(19) United States
(12) Patent Application Publication
(10) Pub. No.: US 2008/0077961 A1
(43) Pub. Date: Mar. 27, 2008

(54) Electronic Program Display Apparatus

(75) Inventor: Makoto TAKEMOTO, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/850,247

(22) Filed: Sep. 5, 2007

(30) Foreign Application Priority Data
Sep. 27, 2006 (JP) 2006-262628

(51) Int. Cl. G06F 13/10

(52) U.S. Cl. 725/58

(57) ABSTRACT

In an electronic program display apparatus, a reserved program can be confirmed easily and rapidly from a screen on which a registered program reserved for recording is displayed with a simple operation.

An electronic program display apparatus includes a tuner to demodulate a television broadcast, an EPG acquisition unit to obtain data of an electronic program list, a display to display image signals on a screen, a CPU which has a program reservation means to register a program reserved for recording and to include a list of the programs reserved for recording and a program list display means to display an EPG program list and controls the whole electronic program display apparatus, and a remote controller. In confirming the program reserved for recording, when a user displays the list of the programs reserved for recording with operation keys of the remote controller and selects a reserved program to be confirmed from the list of the programs reserved for recording, an electronic program list corresponding to a date and time and a channel of the program is displayed. Consequently, a newest electronic program list corresponding to the program reserved for recording is rapidly displayed with a simple operation, thus the program reserved for recording can be confirmed easily.

### BACKGROUND OF THE INVENTION

1. Field of the Invention

The present invention relates to an electronic program display apparatus which obtains and displays an electronic program list in a digital television broadcast receiver, a DVD recorder, or the like which receives digital television broadcast signals including data of the electronic program list.

2. Description of the Related Art

As for multi-channel digital television broadcasts including a BS/CS satellite broadcast, a digital terrestrial broadcast, or the like, program service data (names of programs, program contents, program start times, program finish times, program category codes, and so on) are transmitted in addition to transmitting images and audios, in the same manner as conventional an analog broadcast. The digital television receiver and the DVD recorder which obtain such program service data includes an electronic program display apparatus which enables a user to efficiently select programs desired by the user in the multi-channel broadcasts by EPG (Electronic Program Guide) screen display function with OSD (On-Screen Display) function and also to select programs, which are scheduled to be broadcasted, on the EPG, so that the user can make reservation for recording and watching the programs.

However, in such a conventional electronic program display apparatus, when there is a reserved program which the user desires to confirm by watching the screen for reservation in confirming the program contents, whose reservation for recording is already registered, and so on, it is necessary to display an electronic program list with a EPG program display key and afterwards search for a desired program reserved for recording with a key operation on the date and the time in the electronic program list. Furthermore, when displaying the electronic program list with the EPG program display key, a program list of current date and time or a previous program list is generally displayed, so that there is less of display of desired program reserved for recording in such an electronic program list from the start, and it is necessary to scroll the display screen of the electronic program list to display the program list corresponding to the program reserved for recording, thus it takes time to confirm the program reserved for recording and change the reservation for recording.

There is a known digital television broadcast receiver which includes such an electronic program display apparatus described above as shown in Japanese Laid-Open Patent Publication No. 2001-346115. The digital television broadcast receiver in 2001-346115 includes a program guide display means which extracts programs applicable to a user-established category, displays a category search result screen made up of these programs, provides a guide display button beside the category search result screen, set a program guide display time to display other category search programs, which are broadcasted in the same period of time as a program which is tentatively selected by the user by pressing the guide display button or pressing a guide display key in a remote control transmitter, with the program which is tentatively selected by the user, and displays the program guide.

There is also other known digital television broadcast receiver as shown in Japanese Laid-Open Patent Publication No. 2002-290887. In the digital television broadcast receiver in 2002-290887, when a program reserved for recording (recorded program) is selected when a list of the recorded program is displayed on a screen, a mode is switched to a program switching mode, a program guide which is scheduled to be broadcasted is displayed on the screen, and the user selects the program which is not particularly scheduled to be watched from the program guide, then the selected recorded program is regenerated at the time when the program which is not scheduled to be watched is broadcasted.

Moreover, there is also a known electronic program display apparatus as shown in Japanese Laid-Open Patent Publication No. 2003-198978. In the electronic program display apparatus in 2003-198978, lines or rows for user selection are provided in addition to lines or rows for each channel to be displayed in the electronic program list for each channel, and a user selection program which is scheduled to be watched by the user or a reserved program which is reserved to be automatically received when the program is broadcasted is displayed in the user selection lies or rows.

However, the apparatuses shown in the above publications do not enable a transfer to an electronic program list corresponding to a date and time and a channel of the reserved program which is selected when selecting a program to confirm its reservation from the list of programs reserved for recording, and the corresponding electronic program list is not displayed. As a result, it is necessary to move in the program screen with a key operation on the electronic program list to confirm the program contents, whose reservation for recording is already registered, and so on, in the same manner as the above description, so that a troublesome operation is necessary to confirm and change the reservation of the program reserved for recording.

### SUMMARY OF THE INVENTION

The present invention is to solve the problem described above, and an object of the present invention is to provide an electronic program display apparatus which enables a rapid transfer from a screen in which a registered program reserved for recording which is already registered is displayed to an image display of a newest electronic program list with a simple operation and also enables an easy confirmation of a reserved program.

An electronic program display apparatus in accordance with an aspect of the present invention which receives digital television broadcast signals including data of an electronic program list and displays a program list for each broadcast channel, comprising: an electronic program list acquisition means to obtain the data of the electronic program list; a display means to display the electronic program list on a screen; a control means to control the whole electronic program display apparatus, wherein the control means includes a program reservation means so that a user reserves a registration for recording a program and a program list display means to display the electronic program list which is obtained by the electronic program list acquisition means, the program reservation means stores a list of programs reserved for recording which a user reserves a registration, and when a user selects a program reserved for recording to be confirmed from the list of the programs reserved for recording, a program list corresponding to a date and time and a channel of the selected program reserved for recording is obtained by the electronic program list acquisition means and the obtained electronic list is displayed on the display means.

The electronic program display apparatus in accordance with another aspect of the present invention further comprising a remote controller to control the electronic program display apparatus with operation keys, wherein the program list display means displays the list of the programs reserved for recording and an electronic program list corresponding to a date and time and a channel of the selected program reserved for recording on the display means based on a key operation of the remote controller.

According to the configuration described above, when the program reserved for recording to be confirmed is selected from the list of programs reserved for recording to confirm the reservation of the program reserved for recording, the electronic program list corresponding to the date and time and the channel of the selected program reserved for recording can be displayed, so that the contents of the reserved program can be rapidly confirmed.

According to another configuration described above, the program reserved for recording can easily be confirmed with the key operation of the remote controller while watching the display screen.

According to still another configuration described above, when confirming the program contents whose reservation for recording is already registered, the newest electronic program list corresponding to the date and time and a channel of the selected program can be displayed with a predetermined key operation, so that the reserved program can be rapidly confirmed with the simple operation. Moreover, the reserved program which is selected can be displayed in the center of the display screen of the electronic program list, so that the reserved program desired by the user can be found on the display screen, and the newest program data including the other programs can be confirmed, so that the program reserved for recording can be easily changed to the program which the user desires to watch more. Moreover, in case that the start time or the finish time of the program reserved for recording is changed due to the special program scheduling when there is a cyclic reservation for recording on the specified period of time on the specified day of week, the change of the broadcast time can be relatively easily confirmed. Furthermore, the setting of the reservation that the time setting is manually performed can be confirmed easily without using the program list.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a block diagram of an electronic program display apparatus according to an embodiment of the present invention;

FIG. 2 is an appearance diagram of a remote controller of the electronic program display apparatus in FIG. 1;

FIG. 3 is a flow chart showing an operation process of the electronic program display apparatus in FIG. 1;

FIG. 4 is a diagram showing a display example of a list of programs reserved for recording in the electronic program display apparatus in FIG. 1;

FIG. 5A is a diagram showing a display example of an updated newest electronic program list to confirm a program reserved for recoding in the electronic program display apparatus in FIG. 1 and FIG. 5B is a diagram showing a display example when there is a change in a broadcast scheduling of the program reserved for recording in FIG. 5A.

### DESCRIPTION OF THE PREFERRED EMBODIMENTS

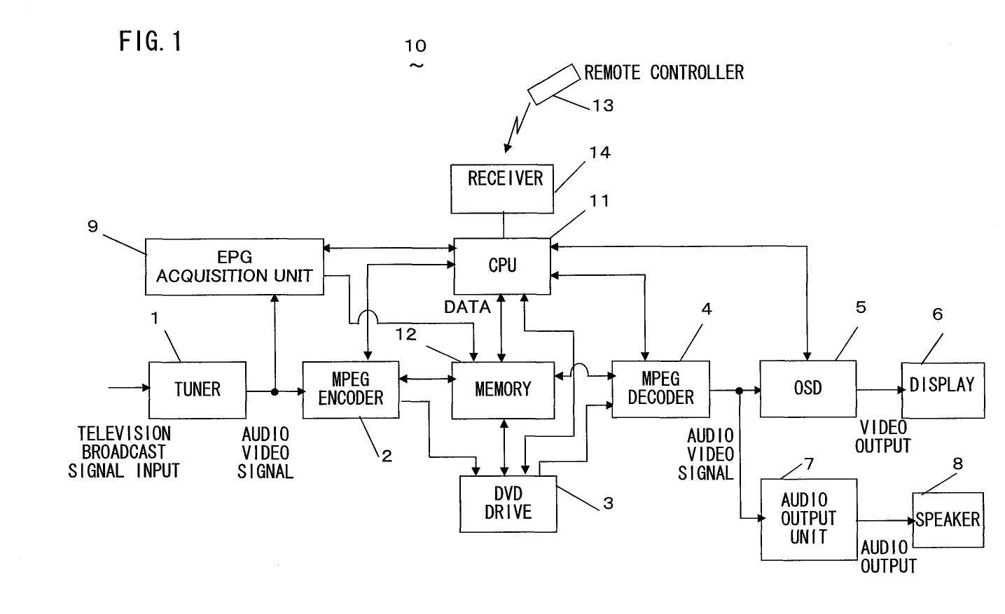

An electronic program display apparatus according to an embodiment of the present invention with reference to FIG. 1 to FIG. 4. An electronic program display apparatus 10 of the present embodiment has a configuration of a picture recorder which can obtain data of an electronic program list, and includes a tuner 1 (audio video demodulation means), a MPEG encoder 2, a DVD drive 3, a MPEG decoder 4, an OSD (On-Screen Display) circuit 5, a display 6, an audio output unit 7, a speaker 8, an EPG acquisition unit 9 (electronic program list acquisition means), a CPU 11 (program reservation means, program list display means, and control means), a remote controller 13, and a receiver 14.

The tuner 1 receives digital television broadcast signals to which data of the electronic program list from an antenna or the like are added, selects channels, demodulates the digital television broadcast signals of the selected channel to output the audio video signals, and inputs the audio video signals to the MPEG encoder 2 and the EPG acquisition unit 9. The audio video signals include added data such as program data from the selected channel as well as the video signals and the audio signals. The MPEG encoder 2 encodes the inputted audio video signals to MPEG signals of DVD format so as to be stored in the DVD drive 3 (including DVD disks), and stores the MPEG signals in the DVD drive 3. The DVD drive 3 stores the audio video signal of the MPEG signals in the DVD disk including DVD-R/RW, DVD+R/RW, DVD-RAM, or the like. When running the DVD drive 3, the MPEG decoder 4 decodes the MPEG signals stored in the DVD disk and regenerates the initial audio video signals. In the audio video signals regenerated by the MPEG decoder 4, the video signals are inputted to the OSD circuit 5 which superimposes the electronic program list, and an output of the ODS circuit 5 is displayed in the display 6. The audio signals included in the audio video signals from the MPEG decoder 4 are inputted to the audio output unit 7 which amplifies the audio, and the audio output is inputted to the speaker 8 and then amplified. The CPU 11 registers the reservation for recording the program through an operation of a user (functions as the program reservation means), displays the electronic program list obtained in the EPG acquisition unit 9 (functions as the program list display means), and controls the whole apparatus. A memory 12 functions as a memory of the CPU 11, the EPG acquisition unit 9, the MPEG encoder 2, the MPEG decoder 4, and so on, respectively. The remote controller 13 is an infrared indirect operation apparatus which controls the electronic program display apparatus 10 with the operation key, and the receiver 14 receives remote control signals from the remote controller 13 and transmits the remote control signals to the CPU 11.

The EPG acquisition unit 9 extracts and obtains electronic program data (program contents, program start times, program finish times, program category codes, and so on are included) from program service data added to the audio video signals from the tuner 1 and stores the data in the memory 12. The CPU 11 makes a program guide which indicates the programs to be broadcasted based on the program data stored in the memory 12 and provides instructions to display the program guide to the OSD circuit 5. The OSD circuit 5 superimposes the EPG signals that the electronic program list is converted into a format of the video signals onto the video signals from the MPEG decoder 4. The video signals on which the EPG signals are superimposed are displayed in the display 6 which is made up of a liquid crystal display or the like, and it is possible to watch the electronic program list through the display 6.

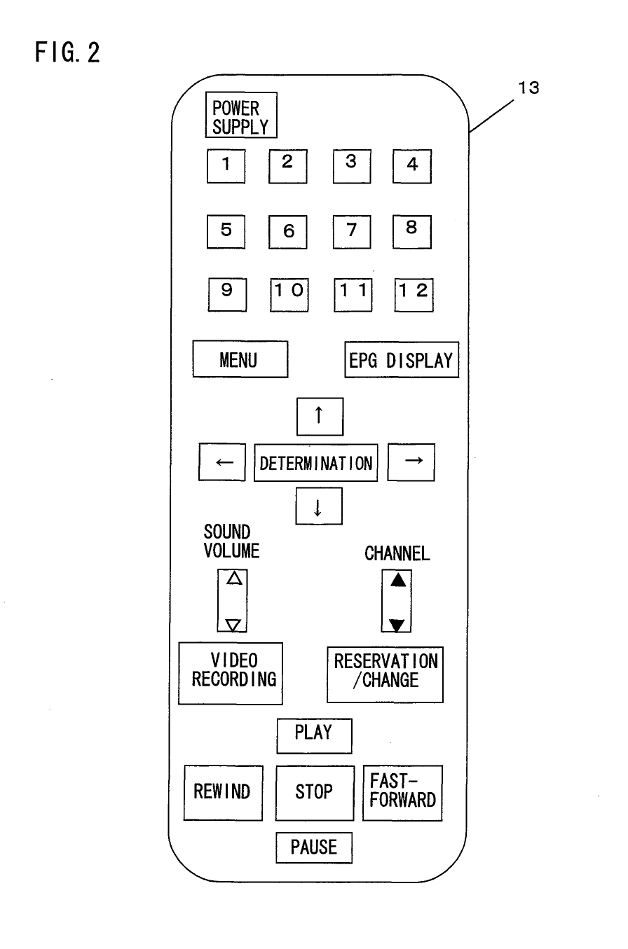

As shown in FIG. 2, the remote controller 13 is a transmitter to send out instructions to the receiver 14. When operating the key on the remote controller 13, signal light (remote control signal) which indicates the instructions corresponding to the key is sent out from a light emitting portion which is not shown in the drawings. The receiver 14 receives the signal light outputted through the key operation of the remote controller 13, converts the signal light into electronic signals and provides the electronic signals to the CPU 11.

To have a reservation for recording the program on the above electronic program display apparatus 10, the user performs necessary input operations with using the remote controller 13. The user can move a cursor with right, left, up, and down arrow keys of the remote controller 13 while watching the program guide on the screen, and have a reservation for recording the program through the CPU 11 by pressing a determination key (or reservation/change key). At this time, the CPU 11 stores the data regarding the selected program to be recorded (the program ID, the name of the program, the broadcast time, and so on) as the data of the reservation for recording. Next, when confirming the program reserved for recording, the user operates the keys in the remote controller 13 and makes the display 6 display the list of programs reserved for recording. At this time, the CPU 11 reads out the data of the reservation for recording from the memory 12, makes the list of programs reserved for recording, and makes the OSD circuit 5 display the screen of the list of programs reserved for recording. When the user moves the cursor on the display screen of the list of programs reserved for recording and operates the determination key of the remote controller 13, the CPU 11 judges that the program reserved for recording is selected, takes out the program reserved for recording selected from the programs reserved for recording which are stored in the memory 12, and displays the electronic program list which includes that program reserved for recording.

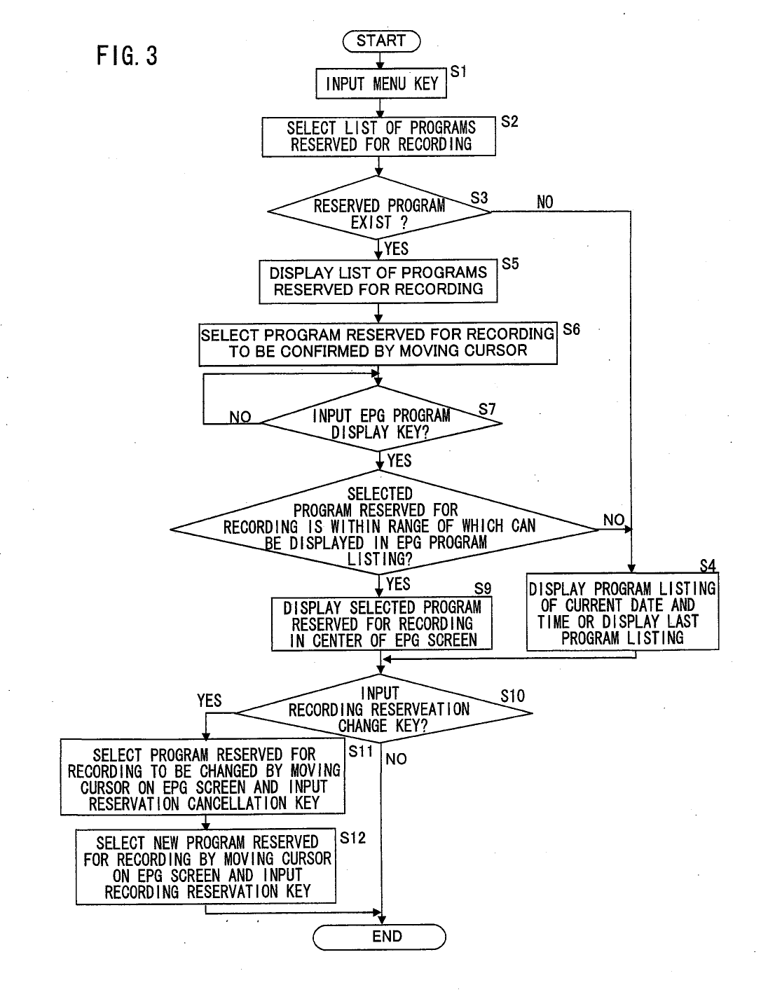

Here, an operation process to confirm the program reserved for recording registered by the user is described with reference to the flow chart in FIG. 3. First, the user presses a menu key to display a program guide of a reservation for recording or a reservation for watching with a key operation of the remote controller 13 (S1), and selects the list of the programs reserved for recording in the menu list of the program guide and presses the determination key (S2), and when there is at least the program reserved for recording in the list of the programs reserved for recording (Yes in S3), the CPU 11 displays the list of the programs reserved for recording (S5). Next, the user selects the program reserved for recording to confirm on the list of the programs reserved for recording with moving a cursor (S6), and the EPG program display key (or the determination key) is inputted (S7), and when the date and the time of the selected program reserved for recording is within the range of which can be displayed in the electronic program list (Yes in S8), the newest electronic program list corresponding to the date and time and the channel of the program selected by the EPG acquisition unit 9 is obtained, and the electronic program list for confirmation is displayed in the display 6 so that the display of the selected program reserved for recording in the electronic program list is positioned in the substantial center of the display 6 and the program list of the channel of this program reserved for recording which includes plural programs in the period of time before and after the broadcast time and the program list of the other plural channels are adjacently positioned around the substantial center of the display 6 in the numerical order of the broadcast channel (S9). Moreover, in case of NO in the step 3 (S3) and in the step 8 (S8), the program list of the current date and time or the previous program list is displayed (S4). Furthermore, when the program reserved for recording is changed in the electronic program list for confirmation in the step 9, the user inputs the recording reservation change key (the reservation/change key) in the remote controller 13 (YES in S10), selects the program reserved for recording to be changed from the EPG screen of the electronic program list with the cursor and inputs the reservation cancellation key (the reservation/change key) (S11), subsequently selects the new program reserved for recording from the EPG screen with the cursor and inputs the recording reservation key (the reservation/change key) (S12), and consequently, the program reserved for recording is changed. Moreover, in case of NO in the step 10, the CPU 11 displays the electronic program list for confirmation, the program list of the current date and time, or the previous program list.

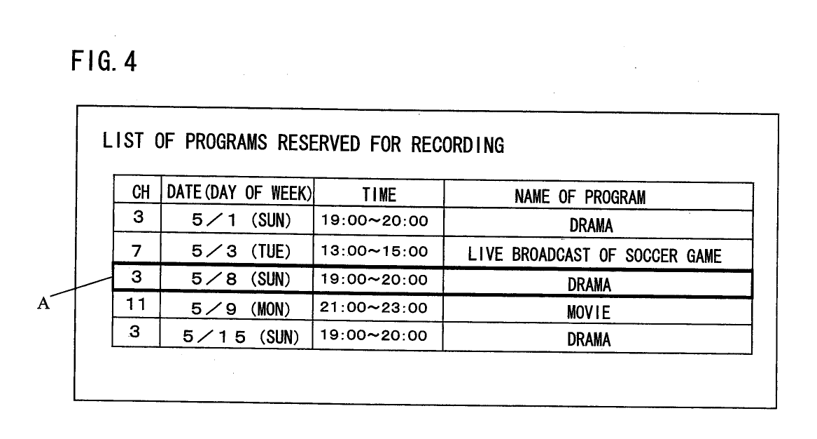

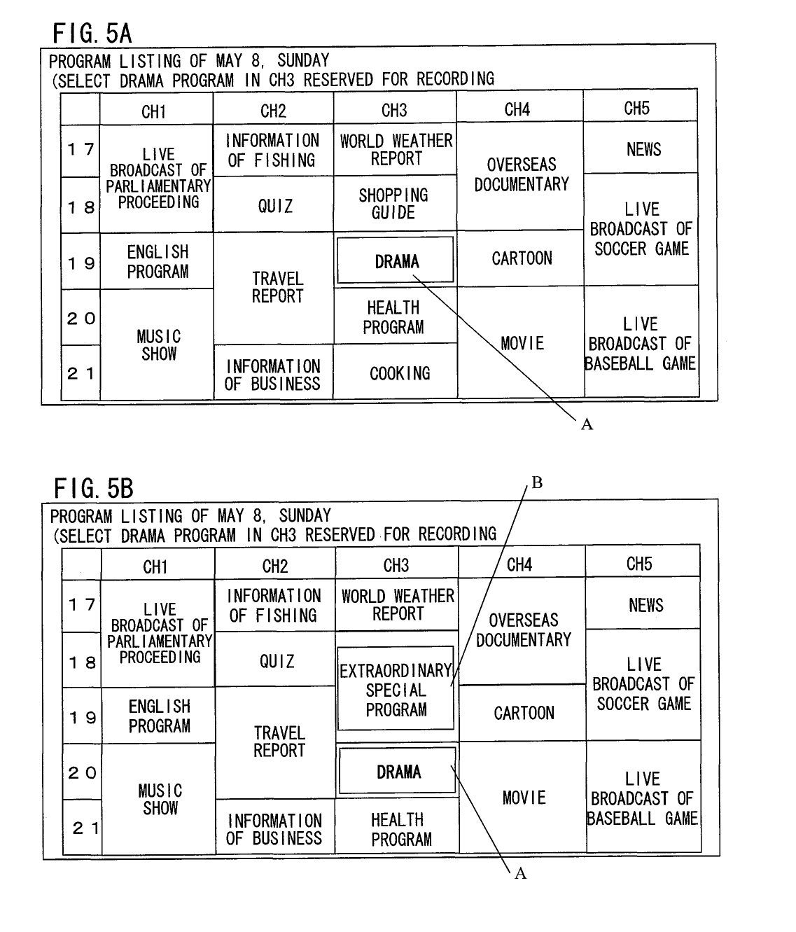

Here, examples of the list of the programs reserved for recording in the step 5 and the electronic program list for confirmation of the program reserved for recording in the step 9 in the above flow chart are described in FIG. 4, FIG. 5A, and FIG. 5B, respectively. FIG. 5A shows the updated program list in case that there is no change in a broadcast scheduling of a program reserved for recording A since the reservation is set, and FIG. 5B shows that there is a change in the broadcast scheduling of the program reserved for recording A in FIG. 5A.

As shown in FIG. 4, there is a cyclic reservation for recording the drama between nineteen and twenty in every Sunday (May 1, 8, and 15) at the CH3 in the example of the list of the programs reserved for recording. Here, when selecting the program A with the cursor of the remote controller 13 to confirm the reservation for recording the drama between nineteen and twenty in May 8, Sunday at the CH3 and pressing the determination key, the updated and newest electronic program list corresponding to the date and time and the channel of the program reserved for recording A to be confirmed is displayed in case that there is no change of the program since the reservation is set. Furthermore, the program reserved for recording A is displayed to be positioned in the substantial center of the EPG display, and the program list which includes the programs in the period of time before and after the broadcast time of the program reserved for recording A and other plural channels is displayed around the program reserved for recording A. In this example, there are five channels, the odd number, as the number of display channels so that the channel for confirmation is positioned to be in the substantial center to position the channel of the program reserved for recording A in the substantial middle of the screen in the lateral direction. According to this configuration, the electronic program list corresponding to the program reserved for recording A to be confirmed can be displayed without the conventional screen scrolling, and moreover, it is possible to rapidly find out the display position of the program to be confirmed in the display screen even when the electronic program list includes the various programs of the multi-channels. Furthermore, the newest program data of the other plural channels can be confirmed, so that it is possible to rapidly detect the program which the user desire to watch more and change the reservation for recording. Furthermore, as shown in FIG. 5B, when the broadcast time of the program reserved for recording A of the drama between nineteen and twenty at the CH3 which is initially reserved is shifted backward for one hour due to an occurrence of an extraordinary special program B and there is the change in the period of time of the broadcast scheduling of the program reserved for recording A to be confirmed from the initial setting, it is possible to recognize at a glance the program change in the electronic program list for confirmation. Consequently, for example, when there is the cyclic reservation for recording on the specified period of time on the specified day of week, the program contents, the change of the reserved start time caused by the special program, and the presence of the extension of finish time can be relatively easily confirmed. Furthermore, the error in setting the reservation that the time setting is manually performed can be confirmed easily without using the program list.

As described above, according to the electronic program display apparatus 10 of the present preferred embodiment, it is possible to transfer from the screen in which the registered program reserved for recording is displayed to the image display of the newest electronic program list corresponding to the date and time and the channel of the selected program with the simple operation of the predetermined key so that the reserved program can be confirmed easily and rapidly. Moreover, the reserved program which is selected can be display in the center of the display screen of the electronic program list, so that the reserved program desired by the user can be easily found on the display screen, and the newest program data including the other programs can be confirmed, so that the program reserved for recording can be easily changed to the program which the user desires to watch more. Moreover, in case that the start time or the finish time of the program reserved for recording is changed due to the special program scheduling when there is the cyclic reservation for recording on the specified period of time on the specified day of week, the change of the broadcast time can be relatively easily confirmed. Furthermore, the setting of the reservation that the time setting is manually performed can be confirmed easily without using the program list.

Moreover, when the user selects one reserved program from the list of the programs reserved for recording and confirms it in the electronic program list, and when the user subsequently desires to confirm the other program reserved for recording, the electronic program lists corresponding to the date and time and the channel of the program reserved for recording can be continuously displayed in the order of the reservation registration by pressing again the reservation confirmation key, for example, with the initial electronic program list for confirmation opened without returning again to the list of the programs reserved for recording. Furthermore, in the above description, the program reserved for recording to be confirmed is positioned in the substantial center of the display screen of the electronic program list, however, the same can be applied to the program selected in the electronic program list or the like in the other reservation confirmation including the confirmation of the program reserved for watching except for the confirmation of the program reserved for recording.

The present invention is achieved by the various embodiments, however, but not limited to them. Any modification is applicable without departing from the scope of the invention. For example, the electronic program list can be displayed with selecting the necessary channel number, instead of in the numerical order of the channels as described in the preferred embodiment, and it is also applicable to display the program list of the multi-channel instead of the five channel display. Moreover, the program desired by the user can be found out more easily by making a background color of the display screen of the program to be confirmed have a color different from the other area of the display screen, by making a display letter to have a letter different from that of the other programs, or the like.

The preferred embodiment applying the present invention is described above, however, the present invention is not limited to such a preferred embodiment, and various modifications are applicable in accordance with a purpose of use.

What is claimed is:

1. An electronic program display apparatus which receives digital television broadcast signals including data of an electronic program list and displays a program list for each broadcast channel, comprising:
an electronic program list acquisition means to obtain the data of the electronic program list;
a display means to display the electronic program list on a screen;
a control means to control the whole electronic program display apparatus, wherein
the control means includes a program reservation means so that a user reserves a registration for recording a program and a program list display means to display the electronic program list which is obtained by the electronic program list acquisition means,
the program reservation means stores a list of programs reserved for recording which a user reserves a registration, and
when a user selects a program reserved for recording to be confirmed from the list of the programs reserved for recording, the program list display means obtains a program list corresponding to a date and time and a channel of the selected program reserved for recording through the electronic program list acquisition means and displays the obtained electronic list on the display means.

2. The electronic program display apparatus according to claim 1, further comprising
a remote controller to control the electronic program display apparatus with operation keys, wherein
the program list display means displays the list of the programs reserved for recording and an electronic program list corresponding to a date and time and a channel of the selected program reserved for recording on the display means based on a key operation of the remote controller.

3. The electronic program display apparatus according to claim 2, wherein
the program reservation means stores the list of the programs, and displays the list of the programs reserved for recording on the display means in case that the program reserved exists in the list, when the list of the programs reserved for recording is selected with the operation keys of the remote controller so that the user confirms a registered programs reserved for recording.

4. The electronic program display apparatus according to claim 2, wherein
the program list display means obtains a date and time and a channel of the selected program reserved for recording and a newest electronic program list corresponding to channels in a period of time of the date and time before and after the selected program reserved for recording and adjacent channels and displays the obtained electronic program list on the display means so that contents corresponding to the date and time and the channel of the selected program reserved for recording is positioned in a substantial center of a display screen, and contents of the channels in the period of time of the date and time before and after the selected program reserved for recording and adjacent channels are displayed around the program reserved for recording, and
when there is no program reserved for recording on the list of the programs reserved for recording when the date and the time of the selected program reserved for recording is not within a range of which can be displayed in the electronic program list, the program list of the current time or the previous program list is displayed.

5. The electronic program display apparatus according to claim 2, wherein
the program reservation means stores the list of the programs, and displays the list of the programs reserved for recording on the display means in case that the program reserved exists in the list, when the list of the programs reserved for recording is selected with the operation keys of the remote controller so that the user confirms a registered programs reserved for recording,
the program list display means obtains the date and time and the channel of the selected program reserved for recording and the newest electronic program list corresponding to channels in the period of time of the date and time before and after the selected program reserved for recording and adjacent channels and displays the obtained electronic program list on the display means so that contents corresponding to the date and time and the channel of the selected program reserved for recording is positioned in the substantial center of a display screen, and contents of the channels in the period of time of the date and time before and after the selected program reserved for recording and adjacent channels are displayed around the program reserved for recording, and
when there is no program reserved for recording on the list of the programs reserved for recording when the date and the time of the selected program reserved for recording is not within the range of which can be displayed in the electronic program list, the program list of the current time or the previous program list is displayed.

6. An electronic program display apparatus which receives digital television broadcast signals including data of an electronic program list and displays a program list for each broadcast channel, comprising:
an audio video demodulation means to demodulate the digital television broadcast signals into video audio signals;
a display means to display video signals from the audio video demodulation means on a screen;
an electronic program list acquisition means to obtain data of an electronic program list from the video signals;
a control means to control the whole electronic program display apparatus; and
a remote controller to control the electronic program display apparatus with operation keys, wherein
the control means includes a program reservation means so that a user reserves a registration for recording a program and a program list display means to display the electronic program list which is obtained by the electronic program list acquisition means,
the program reservation means stores the list of the programs reserved for recording which a user reserves a registration, and displays the list of the programs reserved for recording on the display means in case that the program reserved exists in the list, when the list of the programs reserved for recording is selected with the operation keys of the remote controller so that the user confirms a registered programs reserved for recording,
the program list display means obtains a date and time and a channel of the selected program reserved for recording and a newest electronic program list corresponding to channels in a period of time of the date and time before and after the selected program reserved for recording and adjacent channels and displays the obtained electronic program list on the display means so that contents corresponding to the date and time and the channel of the selected program reserved for recording is positioned in a substantial center of a display screen, and contents of the channels in the period of time of the date and time before and after the selected program reserved for recording and adjacent channels are displayed around the program reserved for recording, and
when there is no program reserved for recording on the list of the programs reserved for recording when the date and the time of the selected program reserved for recording is not within a range of which can be displayed in the electronic program list, the program list of the current time or the previous program list is displayed.
